(19) United States
(12) Patent Application Publication
(10) Pub. No.: US 2011/0011774 A1
(43) Pub. Date: Jan. 20, 2011

(54) BANKNOTE HANDLING APPARATUS

(76) Inventors: Yasushi Yokota, Hyogo (JP); Masayuki Mukaida, Hyogo (JP)

Correspondence Address: RABIN & Berdo, PC, 1101 14TH STREET, NW, SUITE 500, WASHINGTON, DC, 20005, US

(21) Appl. No.: 12/736,059

(22) PCT Filed: Mar. 4, 2008
(86) PCT No.: PCT/JP2008/053857

§ 371 Date: Sep. 3, 2010

(51) Int. Cl. G07D 13/00; B65B 27/08; B07C 5/00

(52) U.S. Cl. 209/10

(57) ABSTRACT

A banknote handling apparatus 1 of the present invention includes: a recognition unit 6 for recognizing an extent of wrinkle of banknotes to be supplied; a stacking unit 32 to 36 for stacking and sorting the banknotes based on a recognized result of the recognition unit 6; a bundling unit 51 for bundling the banknotes stacked by the stacking unit 32 to 36; and bundling-force control unit 120 for changing, based on the recognized result of the recognition unit 6, bundling forces of a tape adopted when the bundling unit 51 bundles the banknotes.

### TECHNICAL FIELD

The present invention relates to a banknote handling apparatus having a mechanism for stacking a predetermined number of banknotes and bundling the stacked banknotes, and more particularly, relates to a banknote handling apparatus capable of changing bundling forces of a tape when bundling banknotes.

### BACKGROUND ART

In financial institutions, for example, a banknote handling apparatus for arranging collected banknotes, etc., is used. This type of banknote handling apparatus receives the collected banknotes from an inlet into the apparatus, determines the kinds of banknotes, and stacks the banknotes depending on each kind. Predetermined kinds (denominations) of stacked banknotes are respectively transported to a bundling device to be bundled by every 100 sheets unit into a bundle of banknotes (100 sheets of stacked banknotes) by using a tape. Below, regarding the banknotes that have been stacked, those in a state of not having been bundled yet are called stacked banknotes and those in a state of having been already bundled are called a banknotes batch.

How the banknotes are bundled is explained as follows: a tape supported on a reel is fed to the stacked banknotes clamped by clamps and the tape is wound around the stacked banknotes, for example. Then, the tape thus wound is sealed with heat and cut, consequently, the stacked banknotes are bundled (see Patent Document 1 below, for example).

In a banknote handling apparatus described in the Patent Document 1, it is possible to change the tension level of the tape (bundling force) wound around the stacked banknotes by sending forth or pulling back the tape by the reel, so that the bundling force would be adjusted as strong as predetermined setting by an operator. In order to change the bundling forces, however, the operator needs to perform the setting every time.

Herein, the banknotes are primarily distinguished between a substantially unwrinkled normal fit note and a wrinkled rough unfit note. In the stacked banknotes consisting of unwrinkled fit notes, there is no gap between the banknotes. Thus, in order to prevent the bundled banknotes from being removed or dropping out from the banknotes batch, it is required to bundle the stacked banknotes by a relatively strong bundling force. On the other hand, in the stacked banknotes consisting of wrinkled unfit notes, there are many gaps between the banknotes. Thus, in order to prevent warping of the banknotes batch around the bundled portion after the bundling, it is required to bundle the stacked banknotes by a relatively weak bundling force. If the banknotes are removed or drop out from the banknotes batch after the bundling, then there is a probability that the missing banknotes may be miscalculated or stolen, if the banknotes batch is warped, then there is a probability that it may be difficult to pile the banknotes batches. Also, it may be difficult to transport the banknotes batch properly to a device automatically storing the banknotes batches because the banknotes batch may catch on during transporting.

Thus, it is required to change the bundling forces of the tape depending either on when the stacked banknotes consisting of the fit notes are bundled or when the stacked banknotes consisting of unfit notes are bundled. Further, when dealing with the unfit notes, depending on the extent of roughness of the banknotes (extent of wrinkle), it is required to more finely change the bundling forces.

In the banknote handling apparatus, there is a case where a large number of banknotes mixed with the fit and unfit banknotes are received, and after the banknotes are divided into fit and unfit banknotes, the bundling of the stacked banknotes consisting of fit notes and the bundling of the stacked banknotes consisting of unfit notes are continuously performed. In such a case, in the banknote handling apparatus described in the Patent Document 1, the operator should be set to purposely change the bundling forces of the tape depending either on the case where the stacked banknotes consisting of fit notes are bundled or on the case where the stacked banknotes consisting of unfit notes are bundled. As a result, its usability is poor.

Patent Document 1: Japanese Published Unexamined Patent Application No. H9-99912

### DISCLOSURE OF THE INVENTION

### Problem to be Solved by the Invention

The present invention has been achieved in view of the above-described background art, and it is a primary object thereof to provide a banknote handling apparatus capable of improving the usability when bundling forces of a tape are changed at the time of bundling banknotes.

It is another object of the present invention to provide a banknote handling apparatus capable of bundling stacked banknotes favorably according to a state of the banknotes.

### Means for Solving the Problem

A banknote handling apparatus (1) of the present invention is a banknote handling apparatus for handling banknotes, and includes: a recognition unit (6) arranged to recognize an extent of wrinkle of banknotes to be supplied; a stacking unit (32 to 36) arranged to sort and stack the banknotes based on a recognized result of the recognition unit; a bundling unit (51) arranged to bundle the banknotes stacked by the stacking unit; and a bundling-force control unit (120) arranged to control bundling forces of a tape adopted when the bundling unit bundles the banknotes, based on the recognized result of the recognition unit.

In this section, alpha-numerals in parentheses indicate reference numerals of the corresponding components in the embodiments described below. The reference numerals, however, will not limit the scope of the present invention.

According to the above-described configuration, based on the recognized result by the recognition unit (6) whether the amount of wrinkle on the banknotes is large or small, the banknotes are sorted and stacked by the stacking unit (32 to 36). The banknotes that have been stacked (stacked banknotes) are bundled by the bundling unit (51).

Herein, based on the recognized result of the above-described recognition unit, the bundling-force control unit (120) controls the bundling forces of a tape adopted when the bundling unit bundles the banknotes. Depending either on the case of bundling the stacked considerably wrinkled banknotes or on the case of bundling the stacked inconsiderably wrinkled banknotes, the bundling forces of a tape are automatically changed by the bundling-force control unit. Thus, it is possible to improve the usability without a need for an operator to purposely change the bundling forces of a tape.

Moreover, in the banknote handling apparatus (1) of the present invention, based on the recognized result of the recognition unit, a substantially undamaged fit note and a wrinkled unfit note may be sorted.

According to the above-described configuration, based on the extent of the wrinkle, the banknotes are clearly distinguished between the fit notes and the unfit notes. Thus, depending either on the case where the stacked banknotes consisting of the fit notes are bundled or on the case where the stacked banknotes consisting of the unfit notes are bundled, the bundling forces of the tape are reliably changed.

Furthermore, in the banknote handling apparatus (1) of the present invention, the bundling-force control unit may be configured to increase a strength of the bundling force for the inconsiderably wrinkled banknote than the considerably wrinkled banknote, out of the banknotes stacked by the stacking unit.

According to the above-described configuration, for the inconsiderably wrinkled banknotes, the bundling force can be relatively strengthened in order to prevent the banknote from being removed or dropping out from the banknotes batch after the bundling. At the same time, the bundling force for the considerably wrinkled banknotes can be weakened as compared to that for the inconsiderably wrinkled banknotes, and as a result, the bundle of considerably wrinkled banknotes can be prevented from being warped around a bundled portion after the bundling.

Further, in the banknote handling apparatus (1) of the present invention, the recognition unit recognizes, based on the extent of wrinkle, the unfit note into at least two levels of: a first-level unfit note that is relatively inconsiderably wrinkled; and a second-level unfit note that is relatively considerably wrinkled, and the bundling-force control unit may be configured to relatively strengthen the bundling force of the tape for the first-level unfit note and relatively weaken the bundling force of the tape for the second-level unfit note.

According to the above-described configuration, based on the extent of wrinkle, the unfit notes are recognized into at least two levels of: a first-level unfit note that is relatively inconsiderably wrinkled; and a second-level unfit note that is relatively considerably wrinkled. Then, in order to prevent the banknote from being removed or dropping out from the banknotes batch while preventing the warping of the banknotes batch around the bundled portion after the bundling, the bundling force of the tape can be set to be relatively strong for the first-level unfit note. On the other hand, in order to focus on prevention of the warping of the banknotes batch around the bundled portion after the bundling, the bundling force of the tape for the second-level unfit notes can be relatively weakened. Depending on the state of the unfit notes (the extent of the wrinkle), the bundling forces of the tape are appropriately changed so as to be able to bundle the stacked banknotes consisting of the unfit notes favorably.

In the banknote handling apparatus (1) of the present invention, the recognition unit has a function of recognizing also a considerably damaged banknote such as a contaminated banknote and a torn banknote, as the unfit note, and based on a recognized result by the recognition unit that the banknote is the unfit note because of the degree of damage other than the wrinkle, the stacking unit (11, 12, and 32 to 36) stack the banknote recognized as the unfit note separately from the wrinkled note.

According to the above-described configuration, the damaged unfit notes (stained notes, torn notes, etc.) other than wrinkled unfit notes are recognized by the recognition unit, and then, stacked distinguished from the wrinkled unfit note. This enables the bundling-force control unit (120) to control the bundling forces of the tape only when the wrinkled unfit notes and the fit notes are bundled irrespective of the presence of the unfit notes having damage other than the wrinkle, resulting in a favorable bundling of the stacked banknotes depending on the wrinkled unfit notes and the fit notes.

A banknote handling apparatus (1) of the present invention is a banknote handling apparatus for handling banknotes, and includes: a recognition unit (6) arranged to recognize a kind of banknotes to be supplied; a stacking unit (32 to 36) arranged to sort and stack the banknotes based on a recognized result of the recognition unit; a bundling unit (51) arranged to bundle a predetermined number of banknotes stacked by the stacking unit; and a bundling-force control unit (120) arranged to control bundling forces of a tape adopted when the bundling unit bundles the banknotes based on a thickness of the predetermined number of banknotes stacked by the stacking unit.

According to the above-described configuration, based on the recognized result by the recognition unit (6) to which category the banknotes belong, the banknotes are sorted and stacked by the stacking unit (32 to 36). The banknotes that have been stacked (stacked banknotes) up to a predetermined number are bundled by the bundling unit (51).

Herein, based on the thickness of the predetermined number of stacked banknotes, the bundling-force control unit (120) controls the bundling forces of the tape adopted when the bundling unit bundles the banknotes. Depending either on the case of bundling the relatively thick stacked banknotes because of a higher ratio of the considerably wrinkled banknotes or on the case of bundling the relatively thin stacked banknotes because of a higher ratio of the inconsiderably wrinkled banknotes, the bundling forces of the tape are automatically changed by the bundling-force control unit. Thus, it is possible to improve the usability without a need for the operator to purposely change the bundling forces of the tape.

Particularly, with this configuration, even when the banknotes are sorted into each kind of banknotes (denomination) without sorting them depending on the extent of wrinkle, it is still possible to bundle the banknotes with a moderate bundling force.

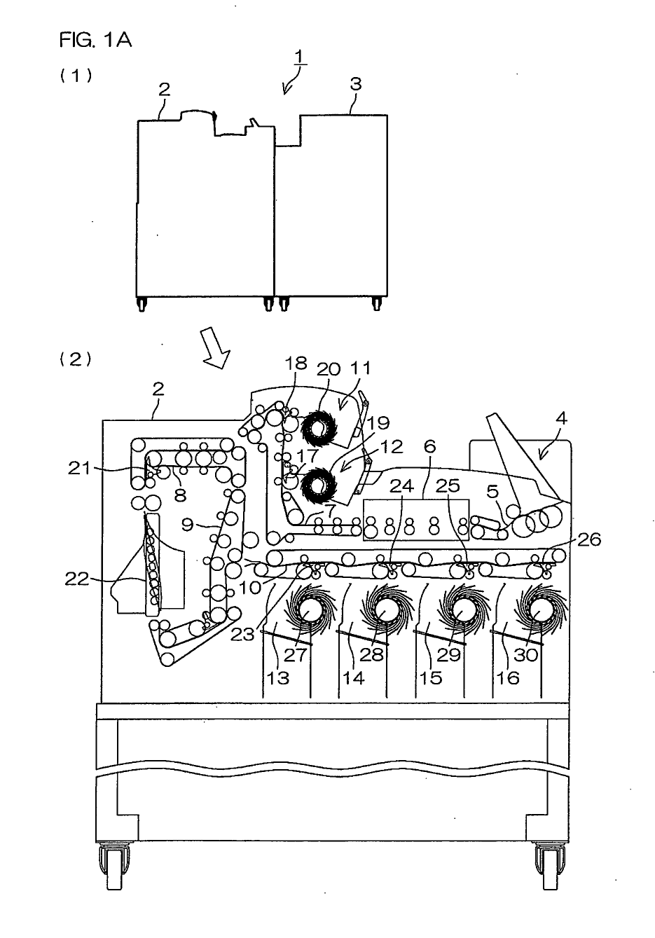

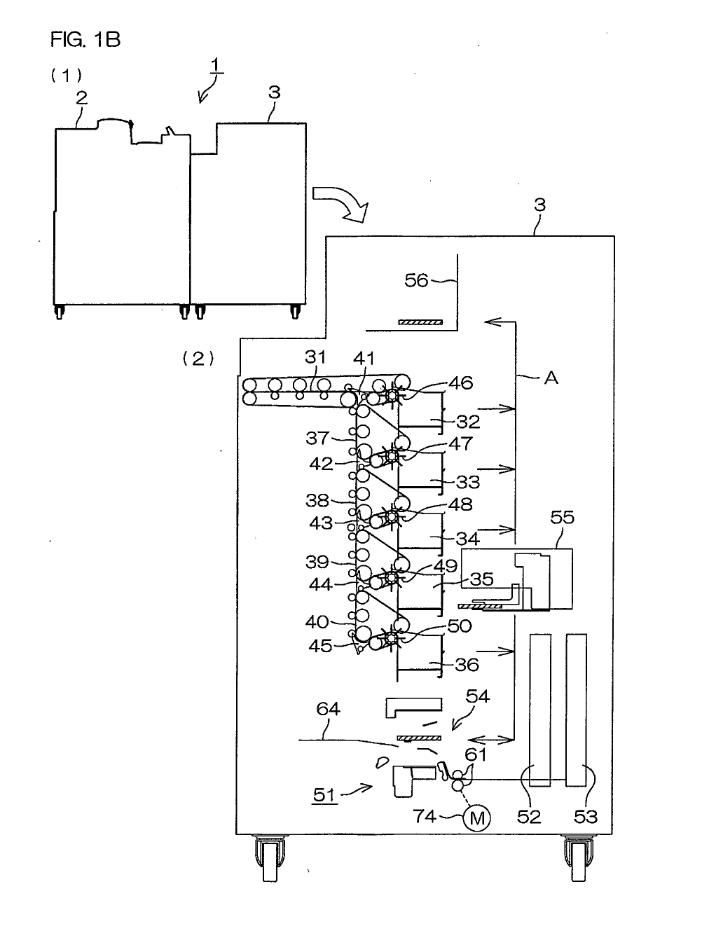

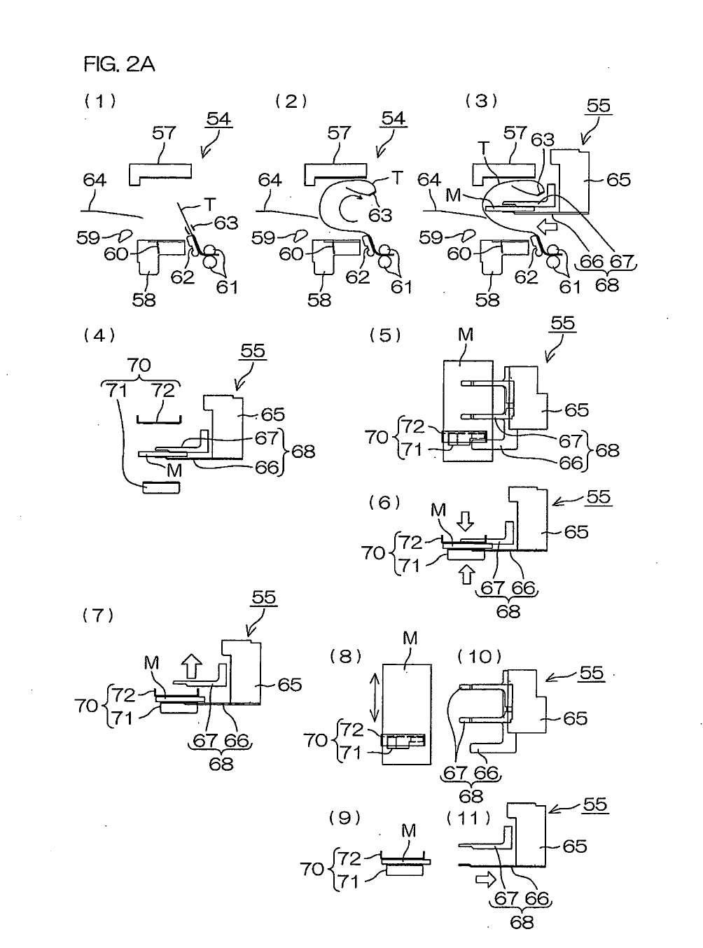

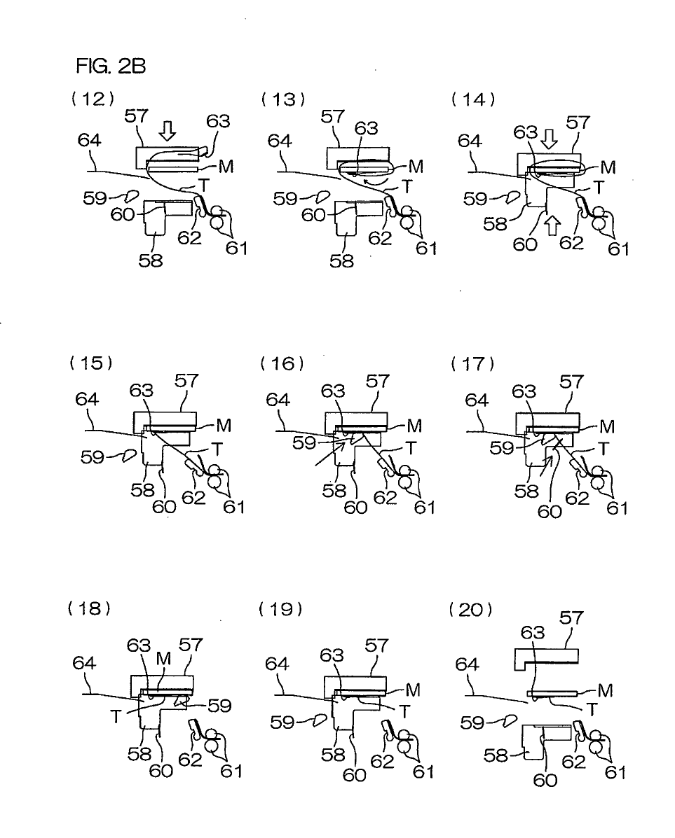

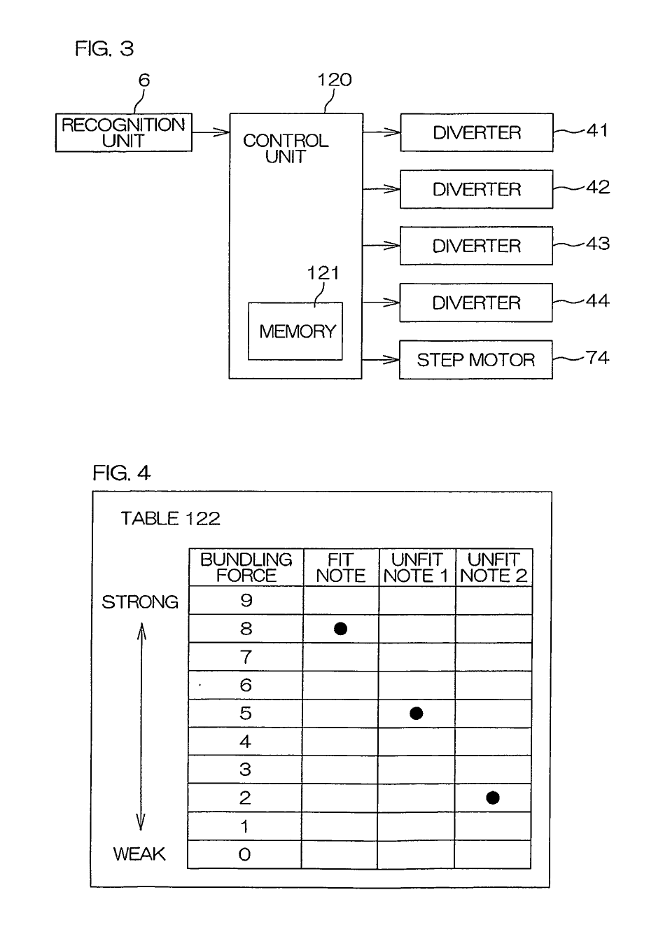

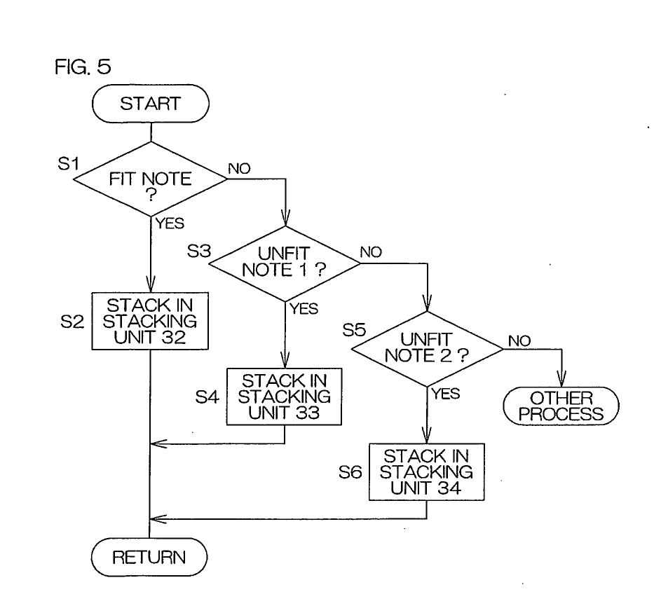

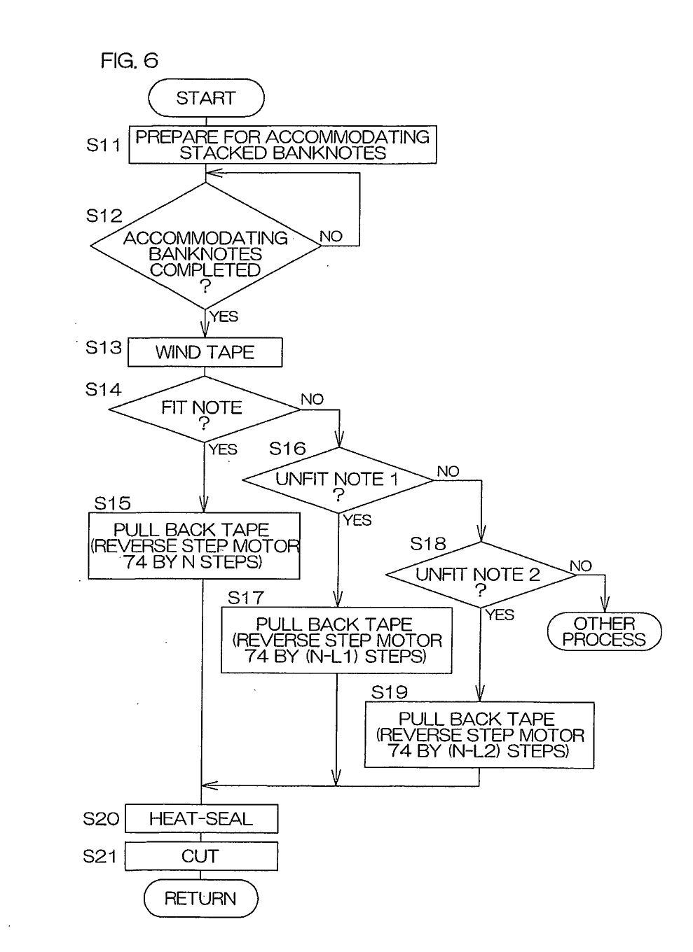

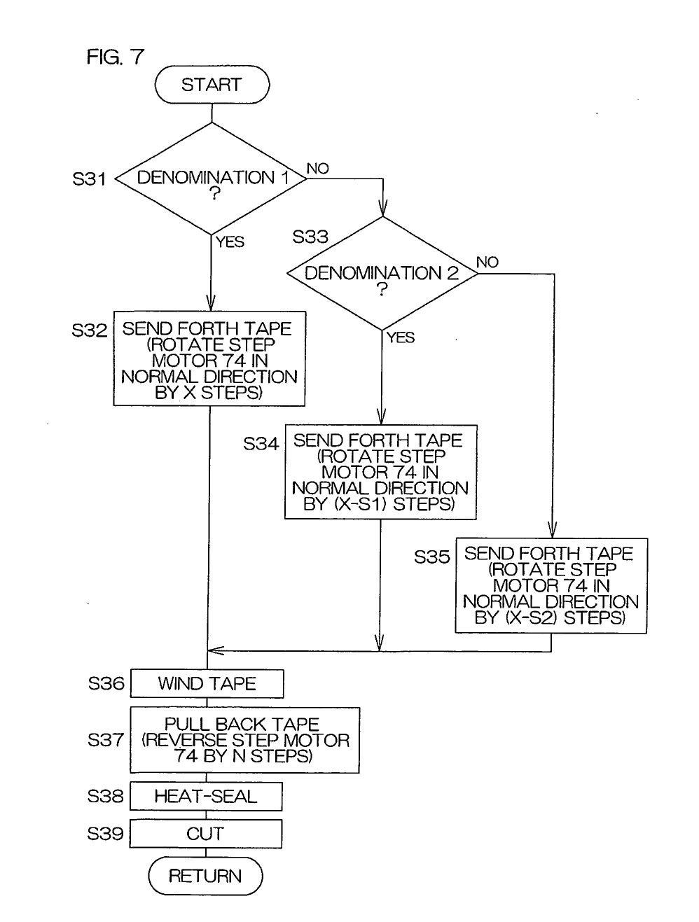

### BRIEF DESCRIPTION OF DRAWINGS

[FIG. 1A] An illustrative vertical cross sectional structural view showing the whole configuration of a banknote handling apparatus according to one embodiment of the present invention.

[FIG. 1B] An illustrative vertical cross sectional structural view showing the whole configuration of the banknote handling apparatus according to one embodiment of the present invention.

[FIG. 2A] An operation explanatory view for describing a bundling operation in a bundling mechanism provided in the banknote handling apparatus according to one embodiment of the present invention.

[FIG. 2B] An operation explanatory view for describing the bundling operation in the bundling mechanism provided in the banknote handling apparatus according to one embodiment of the present invention.

[FIG. 3] A block diagram of a control circuit of the banknote handling apparatus according to one embodiment of the present invention, i.e., a block diagram showing portions associated with features of the present invention.

[FIG. 4] A diagram showing a table stored in a memory of a control unit shown in FIG. 3.

[FIG. 5] A diagram showing one example of a flowchart of a control operation for recognizing and stacking banknotes performed in the control unit shown in FIG. 3.

[FIG. 6] A diagram showing one example of a flowchart of a control operation for bundling the stacked banknotes performed in the control unit shown in FIG. 3.

[FIG. 7] A diagram showing another example of the flowchart of the control operation for bundling the stacked banknotes performed in the control unit shown in FIG. 3.

[FIG. 8] A diagram showing still another example of the flowchart of the control operation for bundling the stacked banknotes performed in the control unit shown in FIG. 3.

### DESCRIPTION OF REFERENCE NUMERALS

1 Banknote handling apparatus
6 Recognition unit
32 Stacking unit
33 Stacking unit
34 Stacking unit
35 Stacking unit
36 Stacking unit
51 Bundling device
120 Control unit

### BEST MODE FOR CARRYING OUT THE INVENTION

Below, with reference to the drawings, embodiments of the present invention will be specifically explained.

<Description of Overview of Whole Configuration>

FIG. 1A and FIG. 1B are illustrative front vertical cross sectional views showing the whole configuration of a banknote handling apparatus 1 according to one embodiment of the present invention.

As shown in FIG. 1A(1) and FIG. 1B(1), the banknote handling apparatus 1 is, as can be seen, configured so that two housings 2 and 3 are linked.

First, with reference to FIG. 1A(2), the first housing 2 is provided with a banknote receiving unit, i.e., a hopper 4. Moreover, the first housing 2 is provided with: a receiving path 5 for receiving banknotes set at the hopper 4; a recognition unit 6 for recognizing a denomination, fit/unfit, genuine/counterfeit, face/back, etc., of the banknotes to be received; transport paths 7, 8, 9, and 10 for transporting the banknotes recognized by the recognition unit 6; two rejected-banknote stacking units 11 and 12; and four stacking units 13, 14, 15, and 16.

Along the transport path 7 for transporting the banknotes that have been recognized by the recognition unit 6, two diverters 17 and 18 are provided. When the diverters 17 and 18 are switched, the banknotes can be stacked in the rejected-banknote stacking units 11 and 12. The rejected banknotes refer to those determined by the recognition unit 6 as unfit notes (notes that are greatly damaged due to contamination or being torn) or counterfeit notes, etc. These rejected banknotes are distinguished from those collected and reused, and are stacked in the rejected-banknote stacking units 11 and 12. In each of the rejected-banknote stacking units 11 and 12, stacking wheels 19 and 20 for accepting and stacking the transported rejected banknotes one by one are provided.

The banknotes other than the rejected banknotes are transported from the transport path 7 to the transport path 8. Along the transport path 8, a diverter 21 is provided. By switching the diverter 21, a banknote can be transported directly to the transport path 9 or transported to the transport path 9 via a reverse path 22. The reverse path 22 is arranged for reversing the face/back of a banknote. The face/back of a banknote is reversed when the banknote passes through the reverse path 22.

The transport path 9 transports the banknotes to the transport path 10 while adjusting a transport time and a timing so that the order of the banknotes directly transported from the transport path 8 and the banknotes transported via the reverse path 22 is not changed.

The transport path 10 extends in a substantially horizontal direction, for example, and below the path 10, the four stacking units 13, 14, 15, and 16 are arranged in line. When the four diverters 23, 24, 25, and 26 provided along the transport path 10 are switched, the banknotes can be stacked into any one of the stacking units 13 to 16. In the respective stacking units 13 to 16, the stacking wheels 27, 28, 29, and for accepting and stacking the banknotes one by one transported from the transport path 10 are provided, respectively.

Along the transport path 10, by controlling the switching of the diverters 23 to 26, the banknotes can be transported to a transport path 31 provided in the adjacent housing 3.

Next, with reference to FIG. 1B(2), in the housing 3, five stacking units 32, 33, 34, 35, and 36 are arranged in line in an vertical direction, for example. Transport paths 37, 38, 39, and 40 are provided for stacking the banknotes in any selected one of the five stacking units 32 to 36.

When the diverter 41 along the transport path 31 is switched, whether to stack the banknotes in the stacking unit 32 or to transport them to the transport path 37 is switched. When the diverter 42 is switched, whether to stack the banknotes in the stacking unit 33 or to transport them to the transport path 38 can be switched on the transport path 37. When the diverter 43 is switched, whether to stack the banknotes in the stacking unit 34 or to transport them to the transport path 39 can be switched on the transport path 38. When the diverter 44 is switched, whether to stack the banknotes in the stacking unit 35 or to transport them to the transport path 40 can be switched on the transport path 39. The diverter 45 on the transport path 40 is fixed in this embodiment, and guides the banknotes toward the stacking unit 36. Each of the transport paths 31, 37 to 40, fin wheels 46, 47, 48, 49, and 50 are provided so as to face the entrance of the stacking units 32 to 36. The fin wheels 46 to 50 promptly stack the banknotes by patting down from above on the rear end of the banknotes, which have been transported from the transport paths 31, 37 to 40 to the stacking unit 32 to 36, and which tend to drop by their own weight. The banknotes are pressed down from above, one by one, by the fin wheels 46 to 50 to be stacked in the stacking units 32 to 36.

At a lower location within the housing 3, for example, a bundling device 51 as bundling unit is provided. The bundling device 51 has a plurality (two, for example) of reeled tapes 52 and 53 and a bundling mechanism 54. The bundling device 51 is for selectively feeding the tape from the reeled tapes 52 and 53 and for bundling the banknotes stacked by the bundling mechanism 54 with the tape.

Within the housing 3, a transport device 55 is further provided. The device 55 extracts the banknotes stacked in the stacking units 32 to 36, transports them to the bundling device 51, and carries a banknotes batch bundled with the tape by the bundling device 51 to outside the housing 3. Moreover, the device 55 is capable of carrying (in a case where a process is ended before the number of banknotes stacked in the stacking units 32 to 36 reach 100 sheets) the banknotes to a banknote returning unit 56 arranged at an upper location of the housing 3. The transport device 55 may move as indicated by an arrow A.

As explained above, out of the collected banknotes fed from an inlet 4, the banknote handling apparatus 1 stacks the rejected banknotes in the rejected-banknote stacking units 11 and 12. At the same time, the apparatus 1 can, for example, sort the banknotes to be reused by denomination, stack them (as loose banknotes) in the stacking units 13 to 16 or bundles the stacked banknotes of a predetermined number, which have been stacked in the stacking units 32 to 36 by denomination, by using the bundling device 51, and arrange them into a banknotes batch.

<Description for Operation of the Bundling Mechanism>

Subsequently, a series of operations for bundling the banknotes transported from the transport device 55 with a tape by using the bundling mechanism 54 will be explained with reference to FIG. 2A and FIG. 2B.

In the bundling mechanism 54, an upper clamp arm 57; a lower clamp arm 58; a heater 59; a cutter 60; a tape-forwarding roller pair 61; a forward guide 62; a holder 63 for holding the tape; and a bundle forward guide 64 are provided (FIG. 2A(1)). Although each component is illustrated in a floating state for convenience, in an actual mechanism, it is held by an arm, a shaft, etc., extending from a side-surface wall, etc.

Moreover, although not illustrated in FIG. 2A(1), the bundling mechanism 54 is provided with a bundling hand for holding the stacked banknotes. The bundling hand will be described later.

A tape T is fed by the roller pair 61, an area near a leading end of the tape T is sandwiched by the holder 63, and the holder 63 is circularly moved along a predetermined moving trail while the roller pair 61 sends forth the tape T. As a result, the tape T is sent forth clockwise in the form of a semi-circular arc. Thus, the bundling mechanism 54 gets ready for accommodating the stacked banknotes (FIG. 2A(2)). Herein, the roller pair 61 is rotated by drive of the dedicated step motor 74 (see FIG. 1B(2)).

To the bundling mechanism 54 that has become ready for accommodating the banknotes, the transport device 55 transports the stacked banknotes M, which are being grasped by the transport device 55 (FIG. 2A(3)). The transport device 55 includes: a base block 65; a lower fork 66 protruding substantially horizontally from the lower end of the base block 65; an upper fork 67 for pressing which is vertically movable from above, toward and away from the lower fork 66. The lower fork 66 and the upper fork 67 function as a transporting hand 68. The stacked banknotes M are sandwiched and held from below and above by the lower fork 66 and the upper fork 67, and transported to the bundling mechanism 54.

The bundling mechanism 54 includes a bundling hand 70 for receiving the stacked banknotes M transported by the transport device 55 from the transporting hand 68, as briefly explained with reference to FIG. 2A(1). FIG. 2A(4) shows a positional relationship between: the bundling hand 70; and the transporting hand 68 of the transport device 55. The transport device 55 shown in FIG. 2A(4) is stopped at the same position as that of the transport device 55 shown in FIG. 2A(3). In FIG. 2A(4), illustrations of the upper clamp arm 57, the lower clamp arm 58, the heater 59, the cutter 60, the roller pair 61, the holder 63, etc., are omitted. In FIGS. 2A(1) to 2A(3), the omitted bundling hand 70 is only shown. Moreover, FIG. 2A(5) is a plan view showing a positional relationship between the transport device 55 and the bundling hand 70, and FIG. 2A(6) is a front view of a state where the bundling hand 70 is closed.

The bundling hand 70 includes a receiving member 71 positioned below and a pressing member 72 positioned above. The receiving member 71 and the pressing member 72 can move upwardly and downwardly in close proximity relative to each other. As shown in FIGS. 2A(5) and (6), these members 71 and 72 can hold sides (as seen from a lengthwise direction) of the stacked banknotes M held by the transporting hand 68. Then, after the bundling hand 70 holds the stacked banknotes M, the upper fork 67 of the transporting hand 68 moves upwardly (FIG. 2A(7)) and the transport device 55 moves to the right side in the drawing. As a result, handing over the stacked banknotes M from the transporting hand 68 to the bundling hand 70 (accommodation into the bundling mechanism 54) is completed.

The bundling hand 70 can also move in a horizontal back-and-forth direction (vertical direction in FIG. 2A(8)). When the bundling hand 70 moves in the back-and-forth direction, the position of the stacked banknotes M within the bundling mechanism 54 can be displaced in the back-and-forth direction, enabling the adjustment of the position when the stacked banknotes M are bundled with the tape T.

Subsequently, with reference to FIG. 2B, a series of process operations for bundling the stacked banknotes M with the tape T will be explained. In addition, in FIG. 2B, the illustration of the bundling hand 70 holding the stacked banknotes M is omitted. However, the stacked banknotes M are held by the bundling hand 70 at a fixed position during the bundling operation.

First, the upper clamp arm 57 is displaced downwardly and the tape T is arranged properly so that the position of the tape T does not deviate (FIG. 2B(12)). In a lower surface of the upper clamp arm 57, a tape guide groove (not shown) concave upward is formed at a predetermined positions in the back-and-forth direction (thickness direction of a paper in FIG. 2B(12)), and the tape is arranged properly by entering the guide groove.

Then, in this state, the holder 63 moves circularly, and as a result, the tape T is wound around the stacked banknotes M along the direction parallel to the short edge of the banknote (FIG. 2B(13)).

When the winding of the tape T is ended, the upper clamp arm 57 and the lower clamp arm 58 move in close proximity relative to each other. As a result, the stacked banknotes M are fixed by being sandwiched from above and below by the upper and lower clamp arms 57 and 58 (FIG. 2B(14)). In the lower clamp arm 58, the tape guide groove is also formed at a predetermined position in the back-and-forth direction, and also in a state where the stacked banknotes M are sandwiched from above and below by the upper and lower clamp arms 57 and 58, the tape T is loosened in its lengthwise direction. Therefore, the roller pair 61 is reversed to pull back the tape T so that the tape T wound around the stacked banknotes M is tightened (FIG. 2B(15)).

Then, the heater 59 is operated to heat the tape T (FIG. 2B(16)). The tape T is a heat seal tape. Thus, when it is heated by the heater 59, overlapped portions of the tape are stuck together.

Subsequently, the cutter 60 is displaced to cut the tape T extending from the roller pair 61 in a direction of the stacked banknotes M (FIG. 2B(17)).

After the cutting, the cutter 60 is returned to its original position, and the tape extended from the roller pair 61 to the direction of the stacked banknotes M is pulled back to a position of the forward guide 62. On the other hand, the tape T on a side of the stacked banknotes M is traced to the end by the heater 59, and the tape T is heat-sealed up to the end (FIG. 2B(18)).

Thereafter, the heater 59 is restored to its original position (FIG. 2B(19)), and then, the upper and lower clamp arms 57 and 58 are kept apart in a direction separated from each other. Then, the bundling is completed (FIG. 2B(20)).

Subsequently, in order to remove the holder 63 holding the tape T from the tape T, the holding force of the holder 63 is cancelled, and the holder 63 is released backwardly (in the direction vertically deeper relative to the paper in FIG. 2B(20)). As a result, the holder 63 is separated from the tape T. Now, the stacked banknotes M becomes the banknotes batch M bundled by the tape is transported to the left direction (FIG. 2B(20)).

In addition, the bundled banknotes batch M may be discharged to outside the housing 3 by the bundling hand 70. Also, the banknotes batch M may be optionally carried to a storage (not shown).

When two bundlings are performed on banknotes, the operation is as follows: the bundling hand 70 moves in the right direction while holding the stacked banknotes M bundled at one location by the bundling hand 70 (see FIG. 2A(7)). Thereafter, the tape and accommodation for the stacked banknotes M are prepared as shown from FIG. 2A(1), where the bundle of banknotes held by the bundling hand 70 is put.

Thus, the series of bundling operations performed by the bundling mechanism 54 have been explained.

### <Control Circuit Block>

FIG. 3 is a block diagram of a control circuit for executing a control operation, which is a feature of the banknote handling apparatus 1, and illustrates a configuration necessary for this characteristic operation of the present invention.

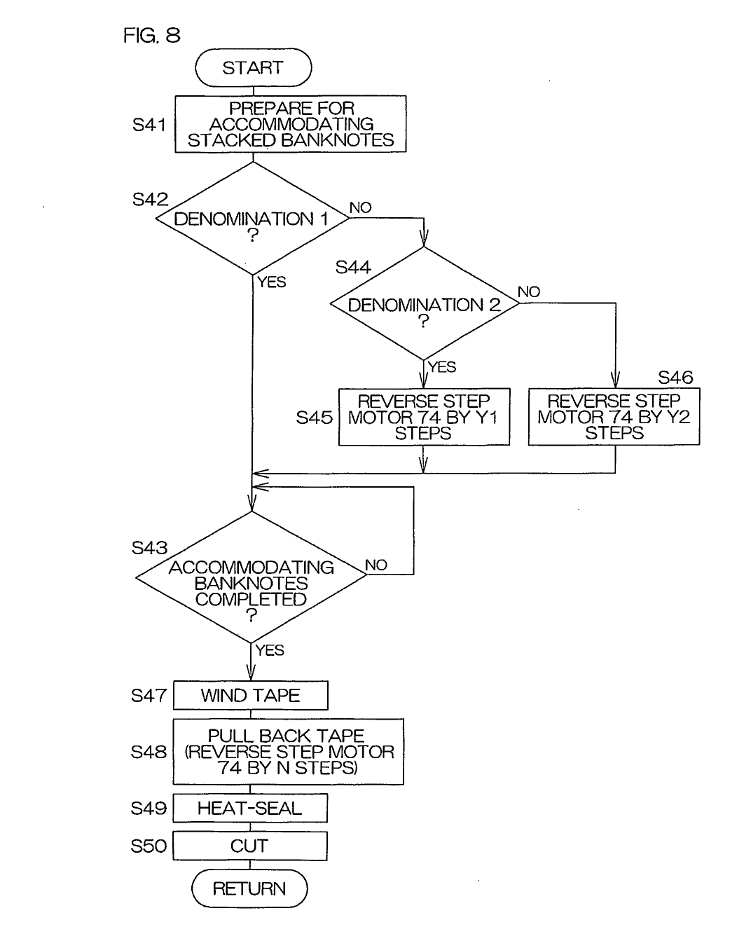

As shown in FIG. 3, the banknote handling apparatus 1 is provided with a control unit 120, as bundling-force control unit, configured by a microcomputer, etc. The control unit 120 switches the above-described diverters 41 to 44 (see FIG. 18(2)), based on the identification information of the banknotes applied from the recognition unit 6. The control unit 120 stacks the banknotes in any one of the stacking units 32 to 36 by switching the diverters 41 to 44.

Moreover, the control unit 120 controls drive of the above-described step motor 74 (see FIG. 1B(2)) in the bundling process, based on the identification information of the banknotes applied from the recognition unit 6. More particularly, the control unit 120 controls rotation directions (forward and reverse) and a rotation amount (step count) of the step motor 74.

In this case, when the step motor 74 rotates forward by a predetermined step count, the above-described roller pair 61 rotates forward that is a direction into which the tape T is sent forth by as much as the above-described step count (see FIG. 2A(2)).

On the other hand, when the step motor 74 rotates reverse by a predetermined step count, the above-described roller pair 61 reverses by as much as the above-described step count in a direction into which the tape T is pulled back (see FIG. 2B(15)). If the tape T is pulled back while the tape T is wound around the stacked banknotes M, then the tape T wound around the stacked banknotes NI is tightened, as described above (see FIG. 2B(15)). The bundling force of the tape T at the time of bundling the stacked banknotes M is strengthened. In this way, the control unit 120 controls the bundling force by using an amount of pulling back the tape T.

The control unit 120 is provided with a memory 121.

FIG. 4 is a diagram showing a table 122 stored in the memory 121 of the control unit 120.

As shown in FIG. 4, the table 122 is stored in the memory 121.

In the table 122, states of the banknotes are distinguished between fit and unfit notes. According to the states of the banknotes, the bundling forces of the tape T for bundling the stacked banknotes are individually set. In this case, the fit note is a substantially undamaged normal banknote while the unfit note is a wrinkled banknote. Moreover, based on the extent of wrinkle, the unfit note is further distinguished between at least two types, i.e., a first-level unfit note that is relatively inconsiderably wrinkled (unfit note 1) and a second-level unfit note that is relatively considerably wrinkled (unfit note 2).

The above-described recognition unit 6 (see FIG. 3) recognizes whether the banknotes supplied to the banknote handling apparatus 1 are fit or unfit depending on the detection, of the wrinkle of the banknotes by using ultrasonic waves, for example, and further recognizes the unfit notes into at least two stages, i.e., the above-described unfit note 1 and the unfit note 2. Moreover, if the unfit note is distinguished not only between the above-described unfit note 1 and the unfit note 2 but also still further distinguished among an unfit note 3, an unfit note 4, . . . , an unfit note N (N is an optional positive whole number), then the recognition unit 6 recognizes into which of the unfit notes 1 to N the unfit note falls.

Further, the recognition unit 6 not only recognizes the extent of wrinkle but also has a function of recognizing, as the unfit note, the banknote having damage other than the wrinkle, i.e., the damaged banknote such as torn note, stained note. In addition, the banknote having damage other than the wrinkle may include a punched note and a tape affixed note. However, in this embodiment, based solely on the presence and the severity of the wrinkle, the strength of the bundling force is adjusted.

In the table 122, the level of the strength of the bundling force is distinguished by a numerical value. When the level of the numerical value is high, this means that the bundling force is set to be strong, while when the level of the numerical value is low, this means that the bundling force is set to be weak. In this case, the bundling force for the fit note is set to level 8 that is near the strongest, for example, while the bundling force for the unfit note 1 is set to level 5 that is weaker than that of the fit note and the bundling force for the unfit note 2 is set to level 2 that is near the weakest.

In this way, the reason why the bundling forces of the tape T for bundling the stacked banknotes are set individually according to the severity of the wrinkle generated on the banknotes is that the size of a gap between the banknotes in the stacked banknotes differs depending on the severity of the wrinkle generated on the banknotes.

When clean banknotes such as the fit notes are stacked, there is almost no gap between the stacked banknotes. Thus, there occurs a problem that unless the stacked banknotes consisting of fit notes are bundled by a moderately strong bundling force, a banknote is removed or drops out from the bundled banknotes batch.

On the other hand, because the surfaces of the wrinkled banknotes such as the unfit notes are rough, and when such unfit notes are stacked, the stacked banknotes inevitably produce a gap between the banknotes themselves. Thus, if the unfit notes are bundled by the bundling force as strong as that for the fit notes, then the bundle of unfit notes is warped, like a fan, around a bundled portion. In some cases, there also occurs a problem that a banknote that is the top surface or the bottom surface in the banknotes batch is rolled into the tape T and thus folded. Generally, the unfit notes will be returned to a central bank after the collection, and thus, banknotes batches of unfit notes are stored in a storage for transport to the control bank. However, it is difficult to stack orderly on top of one another these banknotes batches thus warped in the storage.

That being said, even the unfit notes differ in extent of the wrinkle as is explained in the above-described unfit note 1 and unfit note 2, and thus, if the unfit note 1 is bundled by the weak bundling force as in the case of the unfit note 2, then there occurs a problem that a banknote is removed or dropped out from the bundled banknotes batch of the unfit notes 1, which is similar to the case of the fit note. For the unfit notes, it is required to set an appropriate bundling force according to the extent of the wrinkle, so that the banknote would not drop out of the batch as well as the banknotes batch would not be warped.

### <One Example of Control Operation>

A control operation of the banknote handling apparatus 1 when a plurality of fit and unfit banknotes (the unfit note 1 and the unfit note 2) of the same denomination (for example, 10000 yen fit and unfit notes) are supplied will be described.

FIG. 5 is a diagram showing one example of a flowchart of a control operation for recognizing and stacking the banknotes performed in the control unit shown in FIG. 3. FIG. 6 is a diagram showing one example of the flowchart of the control operation for bundling the stacked banknotes performed in the control unit shown in FIG. 3.

In conjunction with the flowcharts in FIGS. 5 and 6 and with reference to FIGS. 1A, 1B, 3, and 4, the control operation will be described.

First, with reference to FIG. 5, when the control unit 120 determines that the fit note is received based on the information of the banknote recognized by the recognition unit 6 (YES at step S1), for example, the control unit 120 sets the stacking unit 32 as a stacking unit for stacking this fit note, switches the diverters 17, 18, 21, and 23 to 26 on the transport paths 7 to 10 so that the recognized fit note is transported to the stacking unit 32, and switches the diverter 41 on the transport path 31 so that the fit note is stacked in the stacking unit 32 (step S2).

Further, when the control unit 120 determines that the unfit note 1 is received based on the information of the banknote recognized by the recognition unit 6 (YES at step S3), the control unit 120 sets the stacking unit 33, for example, as the stacking unit for stacking this unfit note 1, switches the diverters 17, 18, 21, 23 to 26, and 41 on the transport paths 7 to 10 so that the recognized unfit note 1 is transported to the stacking unit 33, and switches the diverter 42 on the transport path 37 so that the unfit note 1 is stacked in the stacking unit 33 (step S4).

Moreover, when the control unit 120 determines that the unfit note 2 is received based on the information of the banknote recognized by the recognition unit 6 (YES at step S5), the control unit 120 sets the stacking unit 34, for example, as the stacking unit for stacking this unfit note 2, switches the diverters 17, 18, 21, 23 to 26, 41, and 42 on the transport paths 7 to 10 so that the recognized unfit note 2 is transported to the stacking unit 34, and switches the diverter 43 on the transport path 38 so that the unfit note 2 is stacked in the stacking unit 34 (step S6).

In this way, based on the recognized result of the recognition unit 6, the banknotes are sorted into the fit note, the unfit note 1, and the unfit note 2 and stacked in the stacking units 32 to 34. In addition, in the above-described explanation, the fit notes are stacked in the stacking unit 32, the unfit notes 1 are stacked in the stacking unit 33, and the unfit notes 2 are stacked in the stacking unit 34; however, the fit note, the unfit note 1, and the unfit note 2 may be optionally stacked in any one of the stacking units 32 to 36.

Thus, when the fit note, the unfit note 1, and the unfit note 2 are stacked in the corresponding stacking units in the stacking units 32 to 36, the process for bundling the stacked banknotes is implemented, as shown in FIG. 6.

First, when any one of the banknotes, out of the fit note, the unfit note 1, and the unfit note 2 stacked in the corresponding stacking unit in the stacking units 32 to 36, reaches a predetermined number of notes (for example, 100 sheets), the control unit 120 causes the bundling mechanism 54 to perform the above-described preparation for accommodation in order to bundle the 100 sheets of stacked banknotes (step S11). When the control unit 120 rotates and drives the step motor 74 in the forward, the tape T is sent forth in the above-described form of a semi-circle, in the bundling mechanism 54, by the roller pair 61 (see FIG. 2A(2)).

Subsequently, the control unit 120 drives the transport device 55 to transport the 100 sheets of stacked banknotes stacked in any one of the stacking units 32 to 36, to the bundling mechanism 54. Then, upon completion of handing over the stacked banknotes from the transporting hand 68 of the transport device 55 to the bundling hand 70 of the bundling mechanism 54, the accommodation of the stacked banknotes into the bundling mechanism 54 is completed (see FIG. 2A(7)).

When the control unit 120 determines the completion of accommodating the stacked banknotes (YES at step S12), the control unit 120 causes the bundling mechanism 54 to wind the tape T around the stacked banknotes (step S13).

In this case, the control unit 120 determines whether the stacked banknotes are any one of the fit note, the unfit note 1, and the unfit note 2. When the stacked banknotes are fit notes (YES at step S14), the control unit 120 refers to the above-described table 122 and pulls back the tape T wound around the stacked banknotes consisting of fit notes so that the above-described level-8 bundling force can be obtained (step S15). Specifically, the control unit 120 reverses the step motor 74 by predetermined N steps corresponding to the level-8 bundling force. This reverses the roller pair 61 by as much as the N steps to pull back the tape T.

Moreover, when the stacked banknotes are unfit notes 1 (YES at step S16), the control unit 120 refers to the table 122 and pulls back the tape T wound around the stacked banknotes consisting of unfit notes 1 so that the above-described level-5 bundling force can be obtained (step S17). The control unit 120 reverses the step motor 74 by a step count corresponding to the level-5 bundling force. In this case, the step count equivalent to the level-5 bundling force is set to a value (N-L1) obtained by subtracting a predetermined amount L1 from the step count N in the case of the fit note. This reverses the roller pair 61 by as much as the (N-L1) steps to pull back the tape T. In the case of the unfit note 1, the roller pair 61 is reversed in a shorter period of time than in the case of the fit note, and thus, an amount of pulling back the tape T is smaller.

Moreover, when the stacked banknotes are unfit notes 2 (YES at step S18), the control unit 120 refers to the table 122 and pulls back the tape T wound around the stacked banknotes consisting of the unfit notes 2 so that the above-described level-2 bundling force can be obtained (step S19). The control unit 120 reverses the step motor 74 by a step count corresponding to the level-2 bundling force. In this case, the step count equivalent to the level-2 bundling force is set to a value (N-L2) obtained by subtracting L2, which is larger than L1, from the step count N in the case of the fit notes. This reverses the roller pair 61 by as much as the (N-L2) steps to pull back the tape T. In the case of the unfit notes 2, the roller pair 61 reverses in a shorter period of time than in the case of the unfit notes 1, and thus, the amount of pulling back the tape T is much smaller.

After the tape T is pulled back, the control unit 120 drives the heater 59 to perform heat-sealing (step S20). Then, the control unit 120 drives the cutter 60 to cut the tape T (step S21).

Thereby, the bundlings of the stacked banknotes are completed respectively responding to the fit notes, the unfit notes 1, and the unfit notes 2. As described above, the amount of pulling back the tape T wound around the stacked banknotes reaches highest in the case of the fit notes. This is followed by the unfit notes 1. The unfit notes 2 have the least amount. Thus, the stacked banknotes consisting of the fit notes are bundled with a strong bundling force, which is the above-described level 8. The unfit notes 1 are bundled with the level-5 bundling force, which is weaker than the level 8. The unfit notes 2 are bundled with the level-2 bundling force, which is weaker than the level 5.

Thus, the control unit 120 controls the bundling forces of the tape T when the bundling device 51 bundles the stacked banknote, based on the recognized result of the recognition unit 6 whether the banknotes supplied to the banknote handling apparatus 1 is any one of the fit notes, the unfit notes 1, and the unfit notes 2 (i.e., whether the amount of wrinkle of the banknote is large or small). Depending either on the case where the stacked banknotes consisting of the inconsiderably wrinkled fit notes are bundled or on the case where the stacked banknotes consisting of the considerably wrinkled unfit notes (the unfit notes 1 or 2) are bundled, the bundling forces of the tape T are automatically changed by the control unit 120. Thus, it is possible to improve the usability without a need for the operator to purposely change the bundling forces of the tape T.

Based on the extent of the wrinkle, the banknotes are clearly distinguished between the fit notes and the unfit notes. Thus, depending either on the case where the stacked banknotes consisting of the fit notes are bundled or on the case where the stacked banknotes consisting of the unfit notes are bundled, the bundling forces of the tape T are reliably changed.

Moreover, upon bundling the stacked banknotes, the control unit 120 further strengthens the bundling force for the inconsiderably wrinkled fit notes than that for the considerably wrinkled unfit notes. Thereby, it is possible to relatively strengthen the bundling force for the inconsiderably wrinkled fit notes in order to prevent the banknote from being removed or dropping out from the banknotes batch after the bundling, and at the same time, when the bundling force for the considerably wrinkled unfit notes is further weakened than that for the fit notes, warping of the batch of the unfit notes around the bundled portion after the bundling can be prevented.

Moreover, for the unfit notes, the control unit 120 sets the bundling force of the tape T to be relatively strong for the above-described unfit notes 1 and sets the bundling force of the tape T to be relatively weak for the above-described unfit notes 2.

In order to prevent the banknote from being removed or dropping out from the banknotes batch while preventing the warping of the banknotes batch around the bundled portion after the bundling, the bundling force of the tape T can be set to be relatively strong for the relatively inconsiderably wrinkled unfit note 1. On the other hand, in order to focus on prevention of the warping of the banknotes batch around the bundled portion after the bundling, the bundling force of the tape T for the relatively considerably wrinkled unfit notes 2 can be set to be relatively weak. Depending on the state of the unfit notes (the extent of the wrinkle), the bundling forces of the tape T are appropriately changed so as to be able to bundle the stacked banknotes consisting of the unfit notes favorably.

In this embodiment, based on the recognized result of the recognition unit 6, the bundling forces of the tape T are changed depending on the extent of the wrinkle. Alternatively, the following may be possible: the thickness of the banknotes (height of the stacked banknotes) that is obtained when a predetermined number (100 sheets) of banknotes are stacked in the stacking units 32 to 36 (see FIG. 1B), for example, is detected, and based on the height of the stacked banknotes, the bundling force of the tape T may be controlled.

More specifically, the stacking units 32 to 36 each include a bottom surface elevated by the stepping motor (not shown) according to the state of stacking the banknotes, and further include a light-shielding sensor (not shown) for detecting the upper end of the stacked banknotes. In this configuration, when the banknotes are put into the stacking units 32 to 36, a signal from the light-shielding sensor is received, and if there is light-shielding by the banknotes, then it is determined that the upper end of the banknotes is high. In this case, the bottom surface is descended.

The top surface of the stacked banknotes is lowered to a position at which the banknote to be stacked next can easily enter.

In this configuration, when 100 sheets of banknotes of a predetermined kind are stacked, it is possible to detect how far the bottom surface is lowered (height of the stacked banknotes), by counting a rotation pulse count of the stepping motor. When the rotation pulse count (the height of the stacked banknotes) is higher, it is determined that the considerably wrinkled banknotes are stacked. In this case, the banknotes are bundled with a weak bundling force. On the other hand, when the rotation pulse count is smaller (when the height of the stacked banknotes is lower), it is determined that the inconsiderably wrinkled banknotes are stacked. In this case, the banknotes are bundled with a strong bundling force.

In other words, depending either on the case of bundling the relatively thick stacked banknotes because of a high ratio of the considerably wrinkled banknotes or the case of bundling the relatively thin stacked banknotes because of a high ratio of the inconsiderably wrinkled banknotes, the bundling forces of the tape T are automatically changed. Thus, there is no need for the operator to purposely change the bundling forces of the tape T, resulting in improvement in usability.

Moreover, in this configuration, even when the banknotes are sorted into each denomination without sorting into the unfit and fit notes according to the extent of the wrinkle, it is possible to bundle the banknotes with a moderate bundling force. Thus, it is possible to prevent the banknote from being removed or dropping out from the banknotes batch and warping of the banknotes batch.

### <Another Example of the Control Operation>

Another example of the control operation for bundling the stacked banknotes will be described. The control operation explained herein is performed under the circumstance where the dimension of a short edge of the banknote differs by denomination.

For example, the dimensions of the short edges of the Japanese banknotes are equal among every denomination, however, the dimension of the short edge of the Euro banknotes differs by denomination. Upon bundling the stacked banknotes, the tape T is wound around the stacked banknotes along the direction parallel to the short edge of the banknotes, and thus, if the dimension of the short edge of the banknotes differs by denomination, then the length of the tape T necessary for bundling the stacked banknotes differs by denomination. Therefore, by changing an amount of the tape T to be fed or an amount of the tape T to be pulled back by denomination, bundling can be promptly performed. The following control is a specific control example for promptly bundling the banknotes.

The control operation performed in such a bundling process will be described in conjunction with a flowchart in FIG. 7, with reference to FIGS. 1A, 1B, FIGS. 2A, 2B, and FIG. 3.

With reference to FIG. 7, first, when the control unit 120 determines that, based on the banknote information recognized by the recognition unit 6, the banknote of the denomination having a large short edge dimension (hereinafter, a denomination 1) is received (YES at step S31), the control unit 120 rotates the stepmotor 74 in the forward by predetermined X steps (step S32). In response thereto, the roller pair 61 rotates in the forward by as much as the X steps so as to send forth the tape T. At this time, in order to prepare for accommodating the stacked banknotes of the denomination 1, the tape T is sent forth in the form of a semi-circle with the exact length for bundling the banknotes of a denomination 1 (see FIG. 2A(2)).

On the other hand, when the control unit 120 determines that the banknote of a denomination having a short edge dimension that is second largest to the denomination 1 (hereinafter, a denomination 2) is received, based on the banknote information recognized by the recognition unit 6 (YES at step S33), the control unit 120 rotates the step motor 74 in the forward by (X-S1) steps equivalent to a value obtained by subtracting a predetermined amount S1 from the step count X in the denomination 1 (step S34). In response thereto, the roller pair 61 rotates in the forward by as much as the (X-S1) steps so as to send forth the tape T. In the case of the denomination 2, the roller pair 61 rotates in the forward in a shorter period of time than the denomination 1, and thus, the amount of tape T to be fed is smaller. Thus, in order to prepare for accommodating the stacked banknotes of the denomination 2, the tape T is sent forth in the form of a semi-circle with the exact length for bundling the banknotes of the denomination 2.

In this case, when the banknote of the denomination of which the short edge dimension is smaller than that of the denomination 2 is received (NO at step S33), the control unit 120 rotates in the forward the step motor 74 by (X-S2) steps equivalent to a value obtained by subtracting the S2, which is larger than the S1, from the step count X in the denomination 1 (step S35). In response thereto, the roller pair 61 rotates in the forward by as much as the (X-S2) steps so as to send forth the tape T. In the case of the denomination of which the short edge dimension is smaller than that of the denomination 2, the roller pair 61 rotates in the forward in a shorter period of time than the case of the denomination 2. Thus, the amount of tape T to be fed is even smaller. Thus, in order to prepare for accommodating the stacked banknotes of the denomination of which the short edge dimension is smaller than that of the denomination 2, the tape T is sent forth in the form of a semi-circle with the exact length for bundling the banknotes of this denomination.

Thus, after the completion of sending forth the tape T in order to prepare for accommodating the stacked banknotes by denomination different in the short edge dimension, the stacked banknotes of the corresponding denomination are accommodated in the bundling mechanism 54, as described above. In the bundling mechanism 54, the tape T is wound around the stacked banknotes (step S36).

At this time, the stacked banknotes of each denomination are exactly wound with the tape T sent forth with the exact length at the time of preparing for accommodating the stacked banknotes, as described above. In the case of the denomination 1, the tape T is sent forth with a length relatively longer than the case of the denomination (denomination 2) of which the short edge dimension is smaller than that of the denomination 1, and in the case of the denomination 2, the tape T is sent forth with a length relatively shorter than the case of the denomination 1. As a result, the amounts of tape T to be pulled back after the completion of winding the tape T are made substantially equal in each denomination.

Thus, the control unit 120 is capable of exactly pulling back the tape T even in every denomination once the control unit 120 reverses the step motor 74 by the predetermined N steps (step S37).

After the tape T is pulled back, the control unit 120 drives the heater 59 to perform heat-sealing (step S38). Then, the control unit 120 drives the cutter 60 to cut the tape T (step S39).

Thus, the amounts of tape T to be sent forth in order to prepare for accommodating the stacked banknotes are automatically optimized by denomination different in dimension in the short edge. As a result, the amounts (time) of this tape T to be pulled back after the tape T is wound around the stacked banknotes can be made equal and lesser (shorter) irrespective of the denomination. Thus, in the banknote of which the short edge dimension is small, it does not take a long time to pull back the tape T. As a result, it is possible to prevent the time it takes to bundle the banknotes from differing by denomination.

To exhibit a similar effect, another control operation shown in FIG. 8 can be performed.

In this case, first, the preparation for accommodating the stacked banknotes is made (step S41). The amounts of tape T to be sent forth at this time are constant irrespective of the denomination, and set exactly to bundle the above-described denomination 1 (denomination of which the short edge dimension is large).

Then, in the case of bundling the banknotes of the denomination 1 (YES at step S42), the length of the tape T sent forth in order to prepare for accommodating the stacked banknotes is the exact length to bundle the denomination 1, as described above. The length of the tape T is not adjusted again, and the accommodating of the stacked banknotes of the denomination 1 into the bundling mechanism 54 is directly completed (step S43).

On the other hand, in the case of bundling the above-described denomination 2 (denomination of which the short edge dimension is smaller than that of the denomination 1) (YES at step S44), the tape T sent forth in order to prepare for accommodating the stacked banknotes is too long to bundle the denomination 2, as described above. Thus, the control unit 120 reverses the step motor 74 by predetermined Y1 steps (step S45). As a result, the roller pair 61 is reversed by as much as the Y1 steps so as to pull back the tape T to the exact length to bundle the banknotes of the denomination 2. In this case, when the preparation for accommodating the stacked banknotes is made (step S41), the accommodating of the stacked banknotes is immediately started, and in parallel to the accommodating of the stacked banknotes, the pulling back of the tape T is performed.

Then, in the case of bundling the banknotes of the denomination of which the short edge dimension is smaller than that of the denomination 2 (NO at step S44), the tape T sent forth in order to prepare for accommodating the stacked banknotes is still too long to bundle this denomination, as described above. Thus, the control unit 120 reverses the step motor 74 by Y2 steps larger than the step count Y1 for the denomination 2, in parallel to accommodating of the stacked banknotes (step S46). As a result, the roller pair 61 is reversed by as much as the Y2 steps so as to pull back the tape T to the exact length to bundle the banknotes of the denomination of which the short edge dimension is shorter than that of the denomination 2.

Upon completion of accommodating of the corresponding stacked banknote in each denomination (YES at step S43), the following control operations are the same as those following the step S36 in FIG. 7. First, the tape T is wound around the stacked banknotes accommodated in the bundling mechanism 54 (step S47). At this time, similar to the case in FIG. 7, the tape T that is set in length to the exact length by denomination before accommodating of the stacked banknotes is wound around the stacked banknotes of each denomination. As a result, the amounts of tape T to be pulled back after the completion of winding the tape T are made substantially equal in each denomination.

Thus, the control unit 120 is capable of exactly pulling back the tape T even in every denomination once the control unit 120 reverses the step motor 74 by the predetermined N steps (step S48).

After the tape T is pulled back, the control unit 120 drives the heater 59 to perform heat-sealing (step S49). Then, the control unit 120 drives the cutter 60 to cut the tape T (step S50).

In addition, in this embodiment, the adjustment of the bundling forces is performed through subtraction by using the predetermined step count of the step motor 74 (see FIG. 1B) as a reference (see steps S15, S17, and S19 in FIG. 6); however, the predetermined step count may be set to a data table, and at the time of bundling, the step motor 74 may be driven with reference to the desired data.

Moreover, in this embodiment, the bundling forces are adjusted by using the amount of tape T to be pulled back; however, the bundling forces may be adjusted by using the following methods:

For example, in the state of FIG. 2B(15), if the tape T is tightened around the bundle of banknotes M, then the forward guide 62 is opened and the pulling back is stopped. As a result, the movement of the tape T is fixed. Thereafter, when the heater 59 comes into contact with the tape T (see FIG. 2B(16)), the tape T is forcedly pulled back by pressing of the heater 59. Thus, the step motor 74 loses its steps, resulting in changing the degree of tightening the tape T. When the excitation force of the step motor 74 is strong, the bundling force is strong, and when the excitation force is weak, the bundling force is weak. In this way, when a current passes to the step motor 74 at this time, i.e., the excitation force, is set according to the desired bundling force, it is possible to vary the bundling forces of the tape T.

The present invention is not limited to the embodiments explained above, and can be modified in various ways within the scope of the claims.

1. A banknote handling apparatus for handling banknotes, comprising:
a recognition unit arranged to recognize an extent of wrinkle of banknotes to be supplied;
a stacking unit arranged to sort and stack the banknotes based on a recognized result of the recognition unit;
a bundling unit arranged to bundle the banknotes stacked by the stacking unit; and
a bundling-force control unit arranged to control bundling forces of a tape adopted when the bundling unit bundles the banknotes based on the recognized result of the recognition unit.

2. The banknote handling apparatus according to claim 1, wherein, based on the recognized result of the recognition unit, a substantially undamaged fit note and a wrinkled unfit note are sorted.

3. The banknote handling apparatus according to claim 2, wherein the bundling-force control unit increases a strength of the bundling force for the inconsiderably wrinkled banknote than the considerably wrinkled banknote, out of the banknotes stacked by the stacking unit.

4. The banknote handling apparatus according to claim 2, wherein
the recognition unit recognizes, based on the extent of wrinkle, the unfit note into at least two levels of: a first-level unfit note that is relatively inconsiderably wrinkled; and a second-level unfit note that is relatively considerably wrinkled, and
the bundling-force control unit relatively strengthens the bundling force of the tape for the first-level unfit note and relatively weakens the bundling force of the tape for the second-level unfit note.

5. The banknote handling apparatus according to claim 2, wherein
the recognition unit has a function of recognizing also a considerably damaged banknote such as a contaminated banknote and a torn banknote, as the unfit note, and
based on a recognized result by the recognition unit that the banknote is the unfit note because of a degree of damage other than the wrinkle, the stacking unit stacks the banknote recognized as the unfit note separately from the wrinkled note.

6. A banknote handling apparatus for handling banknotes, comprising:
a recognition unit arranged to recognize a kind of banknotes to be supplied;
a stacking unit arranged to sort and stack the banknotes based on a recognized result of the recognition unit;
a bundling unit arranged to bundle a predetermined number of banknotes stacked by the stacking unit; and
a bundling-force control unit arranged to control bundling forces of a tape adopted when the bundling unit bundles the banknotes based on a thickness of the predetermined number of banknotes stacked by the stacking unit.

7. The banknote handling apparatus according to claim 3, wherein
the recognition unit recognizes, based on the extent of wrinkle, the unfit note into at least two levels of: a first-level unfit note that is relatively inconsiderably wrinkled; and a second-level unfit note that is relatively considerably wrinkled, and
the bundling-force control unit relatively strengthens the bundling force of the tape for the first-level unfit note and relatively weakens the bundling force of the tape for the second-level unfit note.

8. The banknote handling apparatus according to claim 3, wherein
the recognition unit has a function of recognizing also a considerably damaged banknote such as a contaminated banknote and a torn banknote, as the unfit note, and
based on a recognized result by the recognition unit that the banknote is the unfit note because of a degree of damage other than the wrinkle, the stacking unit stacks the banknote recognized as the unfit note separately from the wrinkled note.

9. The banknote handling apparatus according to claim 4, wherein
the recognition unit has a function of recognizing also a considerably damaged banknote such as a contaminated banknote and a torn banknote, as the unfit note, and
based on a recognized result by the recognition unit that the banknote is the unfit note because of a degree of damage other than the wrinkle, the stacking unit stacks the banknote recognized as the unfit note separately from the wrinkled note.

10. The banknote handling apparatus according to claim 7, wherein
the recognition unit has a function of recognizing also a considerably damaged banknote such as a contaminated banknote and a torn banknote, as the unfit note, and
based on a recognized result by the recognition unit that the banknote is the unfit note because of a degree of damage other than the wrinkle, the stacking unit stacks the banknote recognized as the unfit note separately from the wrinkled note.
